(19) United States
(12) Patent Application Publication
(10) Pub. No.: US 2015/0005007 A1
(43) Pub. Date: Jan. 1, 2015

(54) DISPLAYING DEMOGRAPHIC DATA

(71) Applicant: StreetLight Data, Inc., San Francisco, CA (US)

(72) Inventors: Laura Schewel, San Francisco, CA (US); Paul Friedman, San Francisco, CA (US)

(21) Appl. No.: 13/931,179

(22) Filed: Jun. 28, 2013

(51) Int. Cl. H04W 4/02

(52) U.S. Cl. CPC H04W 4/02
USPC 455/456.3

(57) ABSTRACT

A system for displaying a demographic data comprises an input interface, a processor, and an output interface. The input interface is configured to receive a location data of a device and to receive a display type. The processor is configured to determine a user characterization data associated with the device and to determine a probability that the device is associated with a location of interest. The output interface is configured to provide an aggregated characterization data associated with the location of interest for display according to the display type. In some embodiments, the system for determining a demographic data comprises a memory coupled to the processor and configured to provide the processor with instructions. In various embodiments, the device is one of a plurality of devices whose data is received and manipulated in order to determine probabilistic demographic data associated with a location.

### BACKGROUND OF THE INVENTION

There is a tremendous amount of demographic data that could be extremely useful (e.g., to various economic and government parties such as the Department of Transportation, economic planners, real estate professionals, retailers etc.). For example, an owner of a store might like to know where his customers and other people in the area of his store or driving by his store are coming from, what their income distribution is, where else they shop, where they work, etc. in order to better serve them. However, this data is difficult to determine.

### BRIEF DESCRIPTION OF THE DRAWINGS

Various embodiments of the invention are disclosed in the following detailed description and the accompanying drawings.

FIG. 1 is a diagram illustrating an embodiment of a wireless network system.

FIG. 2A is a flow diagram illustrating an embodiment of a process for determining demographic data.

FIG. 2B is a flow diagram illustrating an embodiment of a process for determining a demographic data.

FIG. 2C is a flow diagram illustrating an embodiment of a process for displaying a demographic data.

FIG. 3 is a flow diagram illustrating an embodiment of a process for determining the probability a device is associated with a location of interest.

FIG. 4 is a flow diagram illustrating an embodiment of a process for determining locations associated with a device.

FIG. 5 is a flow diagram illustrating an embodiment of a process for determining a home location.

FIG. 6 is a flow diagram illustrating an embodiment of a process for determining demographics associated with a device.

FIG. 7 is a flow diagram illustrating an embodiment of a process for determining a location representation scaling factor.

FIG. 8 is a line graph illustrating a comparison between the number of visitors to an area on a typical Friday and a special event Friday.

FIG. 9 is a stacked bar graph illustrating data describing visitors to an area during a special event.

FIG. 10A is a bar graph illustrating data describing demographics of visitors to an area.

FIG. 10B is a bar graph illustrating data describing demographics of visitors to an area.

FIG. 11 is a map illustrating data describing home locations of all visitors to a location of interest in a given month.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for displaying a demographic data is disclosed. The system comprises an input interface, a processor, and an output interface. The input interface is configured to receive a location data of a device and to receive a display type. The processor is configured to determine a user characterization data associated with the device and to determine a probability that the device is associated with a location of interest. The output interface is configured to provide an aggregated characterization data associated with the location of interest for display according to the display type. In some embodiments, the system for determining a demographic data comprises a memory coupled to the processor and configured to provide the processor with instructions. In various embodiments, the device is one of a plurality of devices whose data is received and manipulated in order to determine probabilistic demographic data associated with a location.

A system for determining a demographic data is disclosed. The system comprises an input interface configured to receive a location data of a device or group of devices, a processor configured to determine a user characterization data associated with the device or group of devices and to determine a probability that the device or group of devices is associated with a location of interest, and an output interface configured to provide an aggregated characterization data associated with the location of interest. In some embodiments, the system for determining a demographic data comprises a memory coupled to the processor and configured to provide the processor with instructions. In various embodiments, the device is one of a plurality of devices whose data is received and manipulated in order to determine probabilistic demographic data associated with a location.

A system for determining demographic data is disclosed. The system receives as input a set of anonymized cellular telephone data. The data includes a set of cellular device check-ins, each check-in comprising a device identifier or identifier for a group of devices, an approximate location, an uncertainty radius or other metric of accuracy, duration, and/or time. A device or group of devices can be tracked by its identifier through its set of check-ins, drawing the device's path over time. A set of locations can then be associated with the user of the device, including where they live, where they work, where they shop, where they recreate, where they exercise, etc. These locations are very useful on their own (e.g., a shop owner might want to know where his customers live), and they can be used to glean further useful information. Device home locations can be correlated with statistical demographic data (e.g., census data, census-like data, etc.) to determine the statistical demographics of the data (e.g., based on the home location of this device, its user has a 60% chance of being married and a 40% chance of being single). The statistical demographic data can then be reflected back to other locations devices visit, e.g., to determine the demographics of customers of a shop. Learning the habits of a user allows further conclusions to be made, e.g., the user exercises regularly, the user has a lot of disposable income, the user has a large family, etc. These conclusions can be statistically reflected onto a population, allowing new sorts of conclusions to be made (e.g., a general store owner might learn that 60% of his customers enjoy rock climbing, and thus he would be wise to stock energy bars).

The sorts of information that can be determined using the system for demographic data are useful to nearly any person planning an organization, an institution, an individual, and/or a group of individuals that would like to know more about the people involved. Some typical uses include making a change to a retail site (e.g., opening a new location, changing inventory, changing hours, etc.), targeted advertising (e.g., determining where your users live so you can advertise to them there, determining which highways your users drive on so you can choose a billboard, etc.), urban planning (e.g., determining high use corridors to add public transit to, select economic development targets, determining driving bottlenecks, etc.), and determination of the effects of a change in landscape (e.g., how traffic changed when the new shopping center opened or when the off-ramp closed for construction, etc.).

A system for displaying demographic data is disclosed. The system comprises an input interface, a processor, and an output interface. The input interface is configured to receive a location data of a device and receive a display type. The processor is configured to determine a user characterization data associated with the device and determine a probability that the device is associated with a location of interest. The output interface is configured to determine a probability that the device is associated with a location of interest.

In some embodiments, the location data of a device and the display type are received using two separate input interfaces. For example, the location data of a device is received from a server of a telecommunications company (e.g., a cellular telephone provider) and the display type is received from a user.

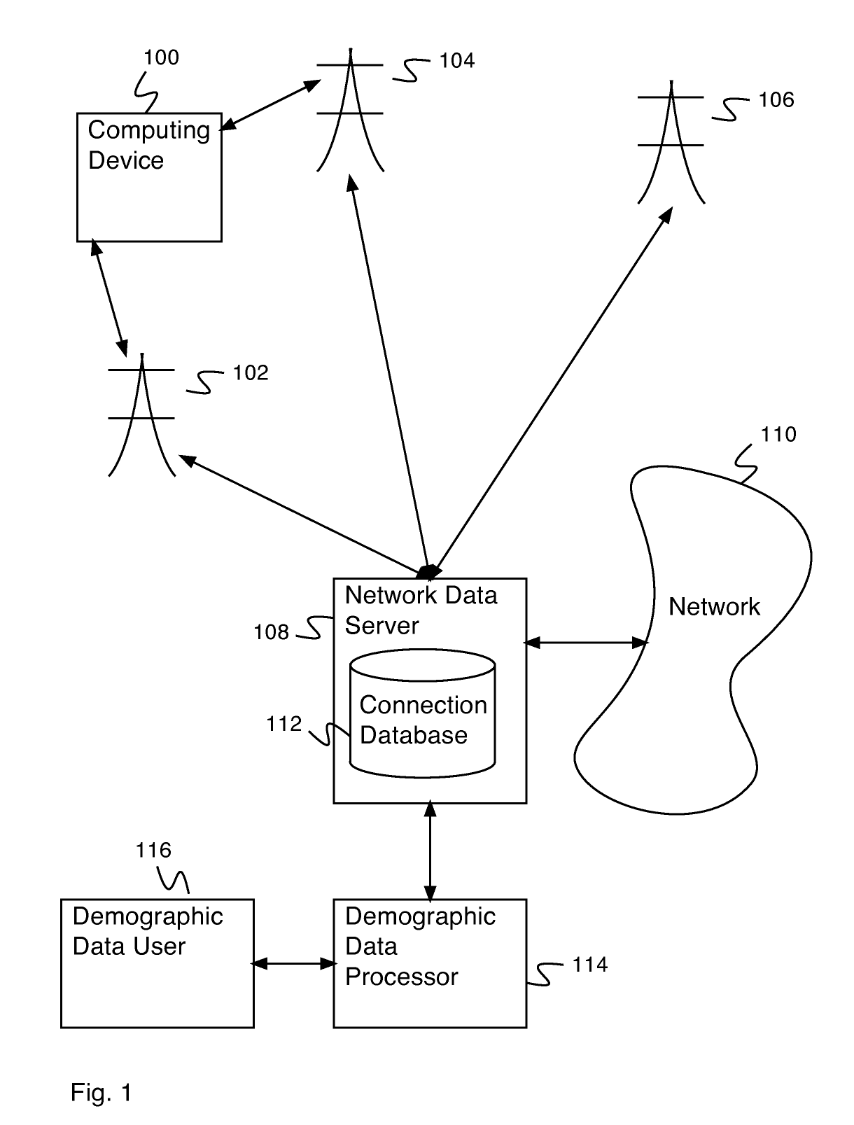

FIG. 1 is a diagram illustrating an embodiment of a wireless network system. In some embodiments, the wireless network system of FIG. 1 comprises a system for determining demographic data. In the example shown, computing device 100 comprises a computing device for accessing a wireless communication system. In various embodiments, computing device 100 comprises a mobile phone, a smartphone, a tablet computer, a laptop computer, an embedded system (e.g., an embedded computing system for controlling hardware), or any other appropriate computing device. In some embodiments, computing device 100 comprises a mobile device. In some embodiments, computing device 100 has an associated device identifier. In some embodiments, the device identifier for computing device 100 comprises a fixed device identifier. In some embodiments, the device identifier for computing device 100 comprises a device identifier that changes on a regular basis (e.g., every day, every 3 days, every week, every month, every year, etc.). In various embodiments, the device identifier is set by the device manufacturer, by the wireless communication system service provider, by the user, or by any other appropriate entity. The wireless communication system comprises computing device 100, wireless transmitters (e.g., wireless transmitter 102, wireless transmitter 104, and wireless transmitter 106), network data server 108, and network 110. Computing device 100 communicates with network 110 via one or more wireless transmitters and network data server 108. In various embodiments, the wireless communication system comprises 1, 2, 5, 22, 100, 1222, 15000, 3,000,000, 30,000,000, millions, tens of millions, hundreds of millions, or any other appropriate number of computing devices. In various embodiments, the communication system comprises 1, 3, 7, 31, 45, 122, or any other appropriate number of wireless transmitters. In various embodiments, network 110 comprises a telephone network, a data network, a local area network, a wide area network, the Internet, or any other appropriate network. In some embodiments, network data server 108 determines a connection location for computing device 100 based on information from wireless transmitters (e.g., which wireless transmitters computing device 100 is communicating with, wireless communication signal strengths, etc.). In some embodiments, network data server 108 is associated with a mobile phone carrier network (e.g., a cellular network) that receives raw data regarding the location of devices associated with the network. In some embodiments, the connection location for computing device 100 comprises a maximum likelihood point and a radius. In some embodiments, a radius comprises a radius within which the device is very likely to be (e.g., the device has a 90% chance of being within the radius). Network data server 108 creates connection database 112 including connection records for connections by computing devices (e.g., computing device 100) to network 110. Connection records in connection database 112 comprise device identifiers (e.g., device identifiers associated with computing devices, e.g., computing device 100), connection locations (e.g., connection locations determined by network data server 108), and connection times (e.g., times associated with a connection). In some embodiments, there are many layers of servers involved in network data server 108 (e.g., one, two, five, six, etc. layers of servers involved), where different companies (e.g., a wireless carrier, a contractor working with a wireless carrier) perform data collection, data manipulation (e.g., refining of location and/or the addition of an anonymized identifier, etc.) before passing the data to the system. At various intervals (e.g., once a day, once a week, upon manual request, etc.), data from connection database 112 is transferred to demographic data processor 114 (e.g., via network 100). Data from connection database 112 comprises a set of connection records. Demographic data processor 114 processes the set of connection records to determine demographic data. In various embodiments, demographic data comprises census data, census-like data (e.g., vehicle age, lifestyle types, purchasing preferences, etc.), age data, income data, ethnicity data, gender data, user type data, heavy shopper data, stay-at-home parent data, commuter data, shopper with disposable income data, college student data, home location data, work location data, previous location data, next location data, visit frequency data, vehicle type data, transit type data, other trip location data, trip routine data, trip type data, competitor data, parental status, age of children, number of children, voting preferences, commute distance, or any other appropriate demographic data. In some embodiments, demographic data comprises demographic data associated with a location of interest. In some embodiments, demographic data processor 114 uses external demographic data (e.g., census data, census-like data, etc.) as part of determining demographic data. In some embodiments, demographic data processor 114 uses connection records in conjunction with demographic data to determine useful information regarding users' travel patterns and statistical data associated with the users based on associated locations (e.g., residence locations, work locations, shopping locations, etc.). Demographic data user 116 accesses demographic data from demographic data processor 114. In some embodiments, demographic data user 116 accesses raw demographic data from demographic data processor 114. In some embodiments, demographic data user 116 accesses prepared reports on demographic data from demographic data processor 114.

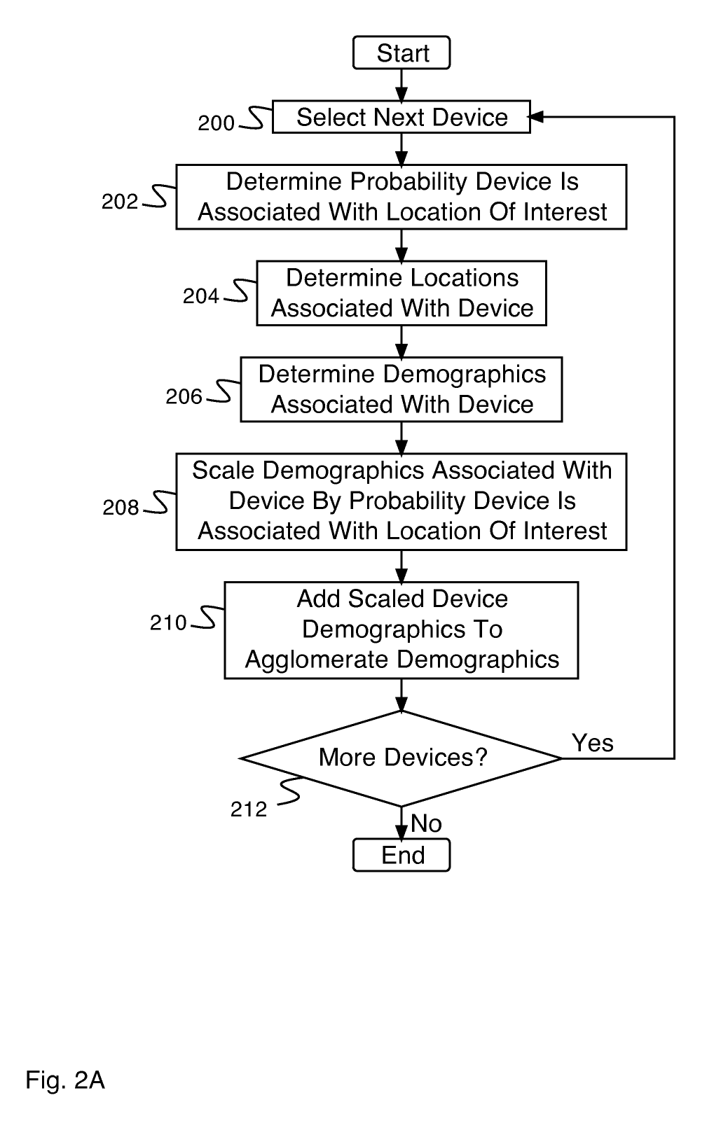

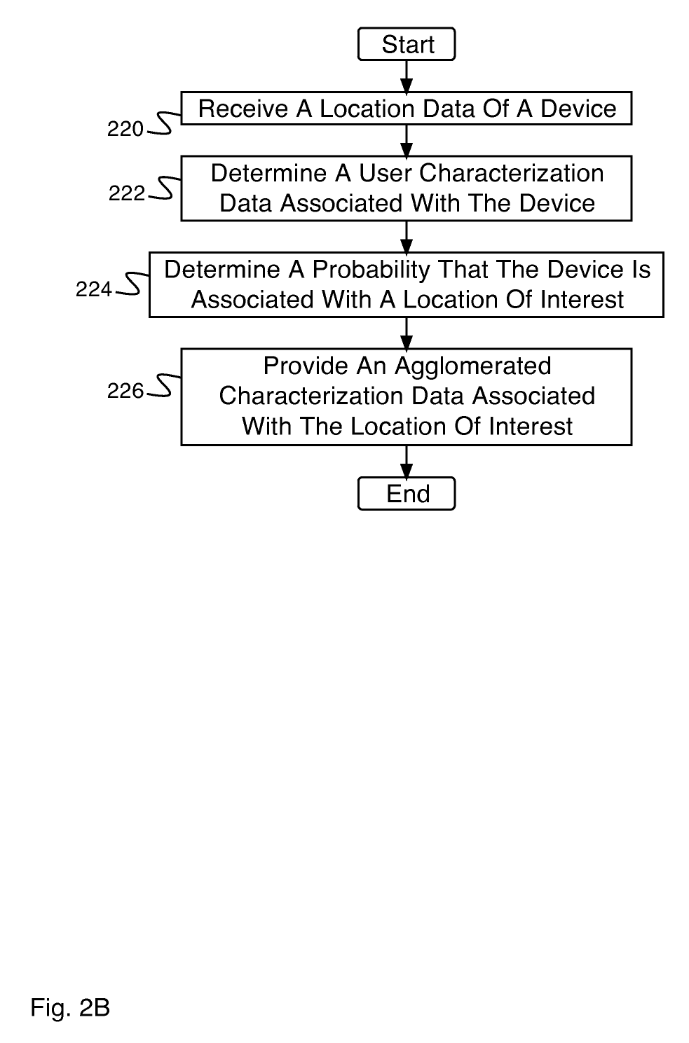

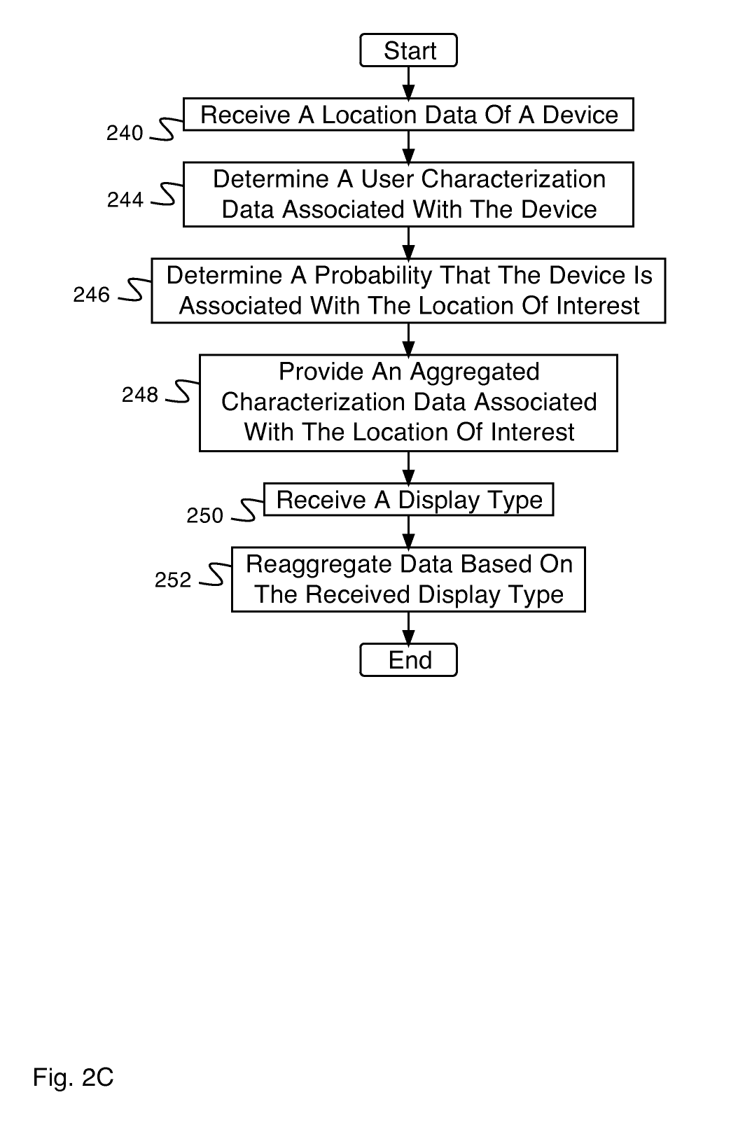

FIG. 2A is a flow diagram illustrating an embodiment of a process for determining demographic data. In some embodiments, the process of FIG. 2A is executed by demographic data processor 114 of FIG. 1 for determining demographic data from a set of connection records. In some embodiments, the process of FIG. 2A operates on a set of connection records sorted by device identifier. In some embodiments, connection records comprise records indicating device identifiers, connection locations, and/or connection times. In some embodiments, a connection location comprises a location probability distribution. In some embodiments, a location probability distribution comprises a maximum likelihood point and a radius. In some embodiments, a set of connection records sorted by device identifier comprises a data set comprising a set of device identifiers, a set of connection locations, and/or associated connection times for each device identifier. In some embodiments, connection records comprising an indeterminate connection location (e.g., where the connection location radius is larger than a threshold value) are discarded prior to the process of FIG. 2A. In some embodiments, the radius threshold value for discarding a connection record varies according to location. In the example shown, the process of FIG. 2A comprises a process for determining demographic data associated with a location of interest.

In 200, the next device is selected. In some embodiments, the next device comprises the first device. In some embodiments, selecting the next device comprises selecting a next device using an identifier.

In 202, the probability the device is associated with the location of interest is determined. In some embodiments, the probability that the device is associated with the location of interest comprises the probability that the device entered the location of interest. In some embodiments, determining the probability the device is associated with the location of interest comprises examining location data and determining whether the location data shows the device near the location of interest (e.g., a connection location shows the device near the location of interest). In some embodiments, the probability that the device is associated with the location of interest comprises the likelihood that the device passed within a threshold distance of the location of interest. In some embodiments, determining the probability the device is associated with the location of interest comprises examining location data and determining whether the location data shows the device passing by the location of interest (e.g., a connection location shows the device first on one side of the location of interest, and then on another side of the location of interest, with a likely path between the two going by the location of interest). In some embodiments, the probability the device is associated with the location of interest comprises a probability as a function of time (e.g., sometimes the device is not near the location of interest, so the probability is zero, but at certain times the device approaches the location of interest, and the probability rises above zero). In various embodiments, the time dependency of the probability the device is associated with the location of interest comprises a dependency on one or more of the following: hour, day, year, month, type of hour, type of day, and/or type of month (e.g., for example, a summer Tuesday, a rush hour, an average weekday, a winter month, paydays, a special event like an art-walk etc.). In some embodiments, the probability=1−(distance [device, location analyzed]/uncertainty radius)̂2 when distance<cut off radius (e.g., Probability=1−(dist [device, location analyzed]/uncertainty radius)̂2 when distance<cut off radius (e.g., 2000 m, 500 m, or any other appropriate cut off radius), otherwise (Probability=0 otherwise).

In 204, locations associated with the device are determined. In various embodiments, locations associated with the device comprise one or more of a home location, a work location, a school location, a shopping location, an exercise location, a work-place location, a recreational location, a tourist location, a frequently-visited friend's home location, or any other appropriate location. In some embodiments, locations associated with the device are determined by examining device locations at location associated times. In some embodiments, locations associated with the device are determined by examining device location patterns.

In 206, demographics associated with the device are determined. In some embodiments, demographics associated with the device are determined by determining demographics associated with the home location or other locations of the device (e.g., the home location determined in 204). In some embodiments, demographics associated with the home location or other locations of the device are scaled by an appropriate scaling factor. In some embodiments, the scaling factor comprises a sum of the partial-population of each census block partially overlapped with a home location for this device/sum of the partial amounts of all devices whose home overlaps with this census block. In some embodiments, the scaling factor is computed as follows:

For each census block: C1

For each device's grid which overlapping with C1: G
C1's factor=C1's census population/sum(% of G which overlaps with C1*G's*G1's factor from 0029)
   For each home grid cell of the device: G

For each census block which overlaps with G: C
Device's factor=sum(% of G which overlaps with C1*C1's factor*G1's factor from 0029)

In some embodiments, demographics associated with the device comprise a demographic probability distribution. In some embodiments, the demographic probability distribution comprises census or census-like data scaled by an appropriate scaling function (e.g. weighting function, etc.). In various embodiments, the census or census-like data comprises one or more of the following: age data, income data, ethnicity data, gender data, employment data, family status data, or any other appropriate data associated with residents or other users of a location.

In some embodiments, the demographic probability distribution comprises user type data. In various embodiments, the user type data comprises one or more of the following: heavy shopper data, stay at home parent data, commuter data, shopper with disposable income data, college student data, work location/commute habits, other mobility patterns, shopping patterns/favorite places, response of user behavior to external events, response or user behavior to weather, response or user behavior to gas prices, response or user behavior to economic factors, gender data, or any other appropriate data.

In 208, demographics associated with the device are scaled by the probability the device is associated with the location of interest. In some embodiments, the probability the device is associated with the location of interest comprises a function of time, and so the scaled demographics comprise a function of time. In some embodiments, the function comprises 1−(1/(usagê2)). In some embodiments, the location of interest has a radius associated with it that does not shrink over time (e.g., in some cases it can grow or remain uncertain for example based on network properties—bounced signals, signals from a far off fall back tower, etc.).

In 210, the scaled device demographics are added to aggregate demographics. In some embodiments, the scaled demographics comprise a function of time, and so the aggregate demographics comprise a function of time. In some embodiments, a scale factor is proportional to (usage/sec by time component)*(average residency time in location in time component). In various embodiments, scaling demographics vary according to time—for example, Sunday vs. Tuesday, a typical Tuesday, a holiday, a sports game day (e.g., a Giants game, a baseball game, a football game, etc.), a school day, a non-school day, a time within a day, a rush hour day, an evening at home day, a part of a day, or any other appropriate time segmenting. In various embodiments, the aggregate demographics comprise a home location probability distribution, a daytime location and/or work location probability distribution, a demographic data probability distribution, or any other appropriate probability distribution. In various embodiments, the demographic data comprises one or more of the following: census data, census-like data, age data, income data, ethnicity data, gender data, user type data, heavy shopper data, stay-at-home parent data, commuter data, shopper with disposable income data, college student data, or any other appropriate demographic data. In various embodiments, the time dependency of the aggregate demographics comprises a dependency on one or more of the following: hour, day, year, month, type of hour, type of day, and/or type of month (e.g., for example, a summer Tuesday, a rush hour, an average weekday, a winter month, paydays, a special event like an art-walk etc.). In 212, it is determined whether there are more devices. In the event there are more devices, control passes to 200. In the event there are not more devices, the process ends.

FIG. 2B is a flow diagram illustrating an embodiment of a process for determining a demographic data. In some embodiments, the process of FIG. 2B is executed by demographic data processor 114 of FIG. 1 for determining demographic data. In the example shown, in 220, a location data of a device is received. In 222, a user characterization data associated with the device is determined. In 224, a probability that the device is associated with a location of interest is determined. In 226, an aggregated characterization data associated with the location of interest is provided.

In some embodiments, an aggregated characterization data comprises an accumulation of products. In some embodiments, each product of the accumulation of products comprises the product of the probability that one of the plurality of devices is associated with the location of interest with the user characterization data associated with the one of the plurality of devices. For example, the owner of a shopping mall is interested in the demographics of the traffic passing by a proposed new location. The probability that a device is associated with the location of interest comprises the probability that a person carrying the device passed by the new location, and the user characterization data comprises the probability that the person carrying the device passed by another shopping location of interest (e.g., a specific retail store such as Whole Foods™, Walmart™, Apple™ Store, Farmer's Markets, shopping malls, etc.). The aggregated characterization data comprises an average of products, wherein each product comprises the product of the probability that one of the plurality of devices is associated with the location of interest with the user characterization data associated with the one of the plurality of devices

In some embodiments, the user characterization comprises a demographic probability distribution. In some embodiments, the demographic probability data comprises census data scaled by an appropriate scaling function. In various embodiments, the census or census-like data comprises one or more of the following: age data, income data, ethnicity data, gender data, employment data, family status data, or any other appropriate census or census-like data. In some embodiments, the demographic probability distribution comprises user type data. In various embodiments, user type data comprises one or more of the following: heavy shopper data, stay at home parent data, commuter data, shopper with disposable income data, college student data, gender data, or any other appropriate user type data.

In some embodiments, the user characterization data comprises an associated location. In some embodiments, user characterization data comprising an associated location comprises an indication of a location associated with a user. In some embodiments, the location is one of a set of possible locations. In various embodiments, an associated location comprises one or more of the following: a specific retail location (e.g., Walmart, Whole Foods, etc.), a recreation location (e.g., a gym, a park, a paracourse, a sports venue, etc.), a school (e.g., a high school, a community college, a private college, etc.), a religious establishment, a social space (e.g., a bar, a park, a square, etc.), or any other appropriate associated location. In some embodiments, user characterization data comprising an associated location comprises an indication of one or more of a set of possible locations. In some embodiments, determining a user characterization data comprising an associated location comprises determining an associated location from a set of location data. In some embodiments, determining a user characterization data comprising an associated location comprises determining, from a set of location data, whether a user was at each of a set of possible locations. In some embodiments, determining a user characterization data comprising an associated location comprises determining, from a set of location data, the probability a user was at each of a set of possible locations. In some embodiments, determining a user characterization data comprising an associated location comprises examining each location in a set of location data and determining the probability that the location comprises one of a set of possible locations.

In some embodiments, the user characterization data comprises a visit frequency. In some embodiments, user characterization data comprising a visit frequency comprises a number of times a location of interest was visited over a given time period. In various embodiments, the time period comprises a day, a week, a month, or any other appropriate time period. In various embodiments, the time period comprises a time period in a day type such as a typical weekday, a weekend day, a commute day, a weekday afternoon when it is sunny, a weekday afternoon when it is foggy, a school day, a non-school day, a school holiday day, a early release day, or any other appropriate day type for data analysis. In some embodiments, determining a user characterization comprising a visit frequency comprises determining, from a set of location data, the number of times a location of interest was visited. In some embodiments, determining a user characterization comprising a visit frequency comprises examining each location in a set of location data and determining the probability that the location comprises the location of interest.

In some embodiments, the user characterization data comprises a visit unusualness. In some embodiments, user characterization data comprising a visit unusualness comprises a metric for how unusual the visit was for the user. In some embodiments, demographic data is used to develop the coefficients of likelihood for each site type/frequency pair and demographic combination. For example, a neural net is trained and a histogram is made for each site type, the type of the location is determined based on a database lookup (e.g., a yellow pages, etc.), the type of location determined based on the probability associated with the stay and the probability associated with the type of location (e.g., stay is longer at a hair salon, but maybe shorter at an automatic teller location).

In some embodiments, the user characterization data comprises a trip type. In some embodiments, user characterization data comprising a trip type comprises an indication of the purpose of the trip the user was taking when the location of interest was visited. In some embodiments, trip type is derived from the combination of site type and trip duration. In various embodiments, trip types comprise one of the following: shopping, grocery shopping, pick-some-else-up, school, work, work-related but out of the office, medical appointment, dining out, social, or any other appropriate trip type.

In some embodiments, the user characterization data comprises competing establishments or other establishments along the route recently. In some embodiments, user characterization data comprising competing establishments or other establishments along the route recently comprises an indication of the competing establishments or other establishments seen on the trip when the location of interest was visited. In some embodiments, once you've found the competing establishments or other establishments, the likelihood is calculated that the device was in the presence of the competitor or other establishment, then the likelihood is aggregate for all the devices at the location of interest. In some embodiments, all establishments are found within an interest radius which have the same Site Type and/or are within or of the same Industry (e.g., all gas stations near my gas station).

In some embodiments, the user characterization data comprises a preceding action. In some embodiments, user characterization data comprising a preceding action comprises an indication of the action of the user prior to visiting the location of interest. In some embodiments, the preceding action comprises a preceding location visited. In various embodiments, the preceding action comprises one or more of the following: leaving home, leaving school, shopping, exercise, running an errand, having lunch, having a meal, and/or having dinner. In some embodiments, the preceding action is calculated using the combination of the previous site type and/or trip type with the current location's site type.

In some embodiments, the user characterization data comprises a following action. In some embodiments, user characterization data comprising a following action comprises an indication of the action of the user after visiting the location of interest. In some embodiments, the following action comprises a following location visited. In various embodiments, the following action comprises one or more of the following: arriving home, arriving at school, shopping, exercise, having lunch, and/or having dinner. In some embodiments, the following action is calculated using the combination of the following site type and/or trip type with the current location's site type. Note that the data is processed post facto so the system is aware of the next location at the time of calculation.

FIG. 2C is a flow diagram illustrating an embodiment of a process for displaying a demographic data. In the example shown, in 240, a location data of a device is received. In 244, a user characterization data associated with the device is determined. In 246, a probability that the device is associated with the location of interest is determined. In 248, an aggregated characterization data associated with the location of interest is provided. In 250, a display type is received. In 252, data is reaggregated based on the received display type. In some embodiments, the reaggregated data is provided to a display for display (e.g., data in the form for display as a table, as a graph, as on a map, etc.).

In various embodiments, the display type comprises a graph of data versus time, a fractional data breakdown, a map, or any other appropriate display type. In some embodiments, in a graph of data versus time, the data comprises a number of visitors to a location of interest. In some embodiments, in a graph of data versus time, the data comprises the subset of visitors to a location of interest of a demographic of interest. In some embodiments, the subset of visitors to a location of interest of a demographic of interest comprises the fraction of the visitors to the location of interest that are members of the demographic of interest. In some embodiments, in a fractional data breakdown, the data comprises visitors to a location of interest. In some embodiments, in a fractional data breakdown, the fractional data breakdown comprises a fractional data breakdown by demographic types of interest. In some embodiments, in a display type comprising a map, the map displays an intensity or density of visitors associated with the location of interest. In various embodiments, in a display type comprising a map, the intensity or the density is associated with a home location, a work location, a school location, a shopping location, an exercise location, a work-place location, a recreational location, a tourist location, a frequently-visited friend's home location, or any other appropriate location. In some embodiments, the map displays changes in visitor characteristics based at least in part on an external factor. In various embodiments, the external factor comprises one or more of the following: a time, a weather condition, an event, or any other appropriate external factor.

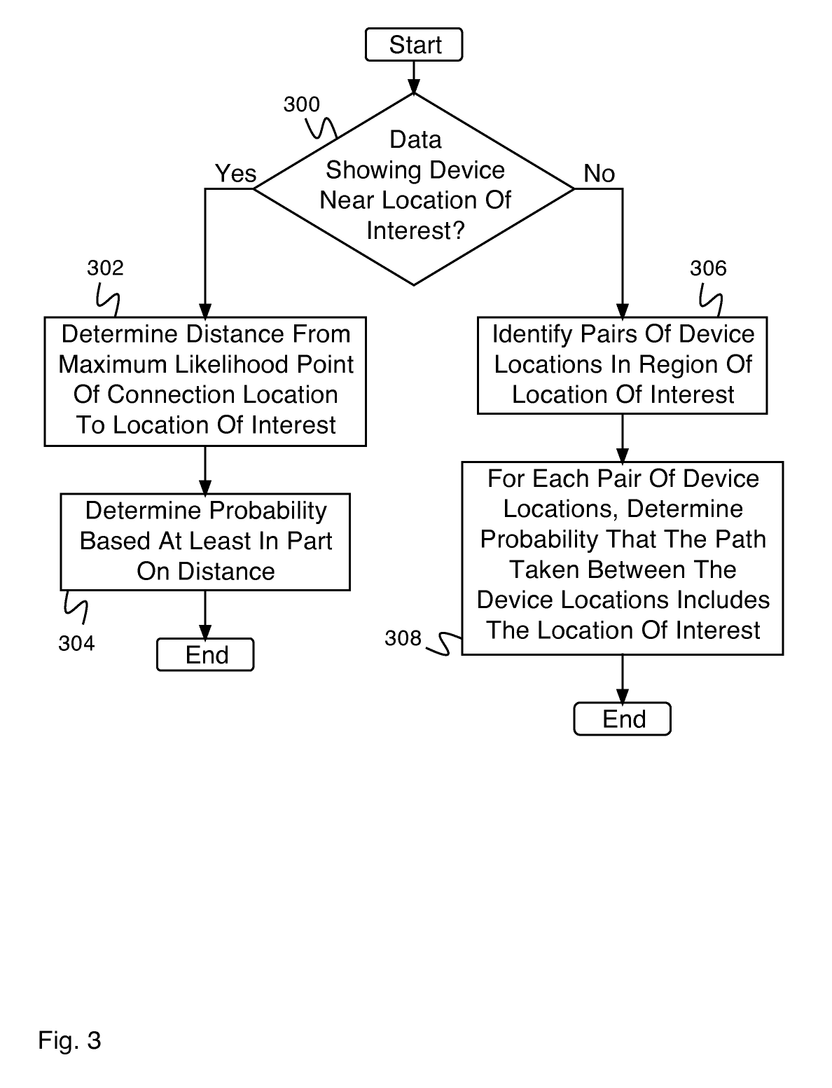

FIG. 3 is a flow diagram illustrating an embodiment of a process for determining the probability a device is associated with a location of interest. In some embodiments, if it is known a device ‘IS’ at the location (e.g., time determined to be stationary at location), this takes precedence over inferring that it might have passed by based on travel inference or habits. In some embodiments, there are two separate metric categories: “who stays there” and “who passes by”. In some embodiments, how long a device or user associated with the device stays at a given location is one of the user characteristics; for example, if it is a really short time (e.g. 1 minute), they're essentially passing by. In various embodiments, the system's estimate of how long they stayed there is another probability function based on the presence of the device, the characterization/known patterns of the place and the size of the location of interest, or any other appropriate manner of determining the length of stay. In some embodiments, the process of FIG. 3 implements 202 of FIG. 2A. In the example shown, in 300, it is determined whether there is data showing the device near the location of interest. In some embodiments, data showing the device near the location of interest comprises a connection record including a connection location radius including the location of interest (e.g., the location of interest is within the circle indicated by the connection location maximum likelihood point and the connection location radius). In the event it is determined that there is data showing the device near the location of interest, control passes to 302. In 302, the distance from the maximum likelihood point of the connection location to the location of interest is determined. In 304, the probability the device was at the location of interest is determined based at least in part on the distance determined in 302. In some embodiments, the probability is determined by looking up the distance in a probability table. In some embodiments, a distance metric is determined to be the ratio of the difference between the connection location radius and the distance determined in 302 with the connection location radius. In some embodiments, the likelihood is a function of the connection and locational accuracy characteristics of all devices in that region (or, conversely, a function of tower and network characteristics in that region). For example, a signal may bounce off of a hill so that locations are offset in one direction (e.g., to the east by an amount in a region where the bouncing is occurring). The distance metric is zero when the distance determined in 302 is equal to the connection location radius (e.g., the location of interest is on the very edge of the circle). The distance metric is one when the distance determined in 302 is zero (e.g., the location of interest is at the connection maximum likelihood point). The probability is determined to be 1 minus 1 divided by the square of the distance metric (e.g., taking into account the area of the circle rather than the distance on a single line from center to edge).

In the event it is determined in 300 that there is not data showing the device near the location of interest, control passes to 306. In 306, pairs of device locations in the region of the location of interest are identified. In some embodiments, pairs of device locations in the region of the location of interest comprise pairs of connection records closely spaced in time with at least one connection location within a threshold distance of the location of interest. In some embodiments, pairs of device locations in the region of the location of interest comprise pairs of connection records closely spaced in time with a path between the device locations passing within a threshold distance of the location of interest. In some embodiments, closely spaced in time comprises within a threshold time difference. In 308, for each pair of device locations, the probability that the path taken between the device locations includes the location of interest is determined. In some embodiments, the probability that the path taken between the device locations includes the location of interest is determined by determining a set of reasonable paths between the device locations (e.g., the five shortest paths, the ten paths that on average take the least time, etc.) determining which of the reasonable paths pass by the location of interest, then determining the probability that each reasonable path that passes by the location of interest was taken. In various embodiments, determining the probability that a reasonable path was taken comprises evaluating the time that a path takes, typical paths for the device user, actual road speed at the time in question, actual road volume at the time in question, or evaluating any other appropriate criteria. The probability that the user passed by the location of interest comprises the probability that the path he took between a pair of device locations took him by the location of interest.

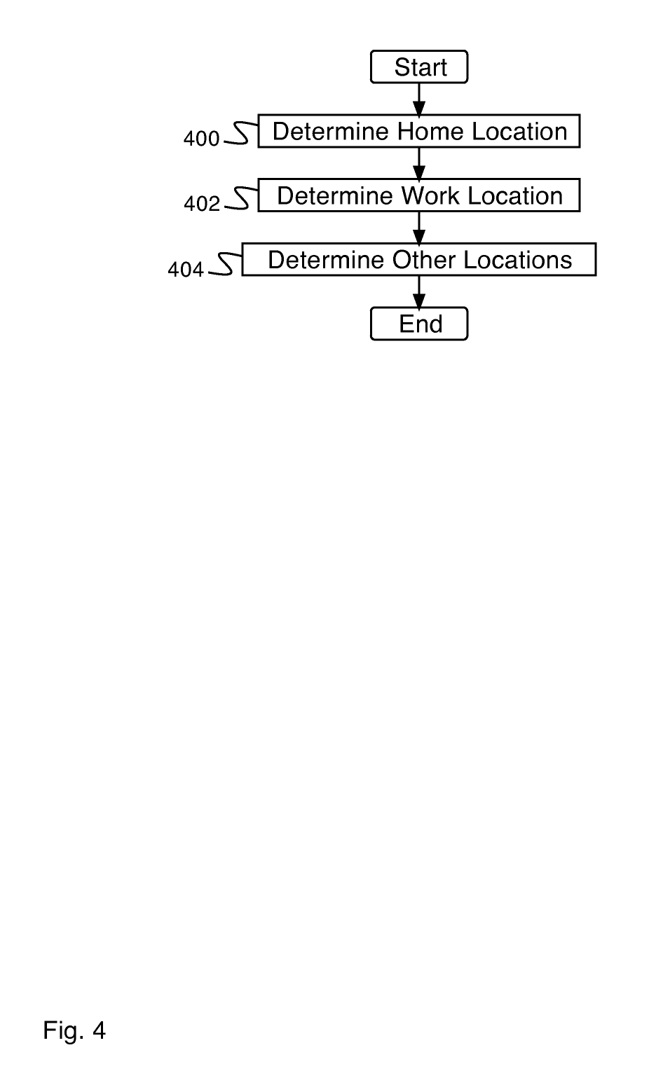

FIG. 4 is a flow diagram illustrating an embodiment of a process for determining locations associated with a device. In some embodiments, the process of FIG. 4 implements 204 of FIG. 2A. In the example shown, in 400, a home location is determined. In some embodiments, a home location is determined based at least in part on connection locations at home-associated times (e.g., at night). In 402, a work location is determined. In some embodiments, a work location is determined based at least in part on connection locations at work-associated times (e.g., at midday). In 404, other locations are determined. In various embodiments, other locations comprise school locations, exercise locations, shopping locations, a work-place location, a recreational location, a tourist location, a frequently-visited friend's home location, or any other appropriate locations. In some embodiments, other locations are determined based at least in part on connection locations at appropriate times. In some embodiments, other locations are determined in other appropriate ways (e.g., a user always exercises between work and home, a user regularly goes to a known shopping center location, etc.).

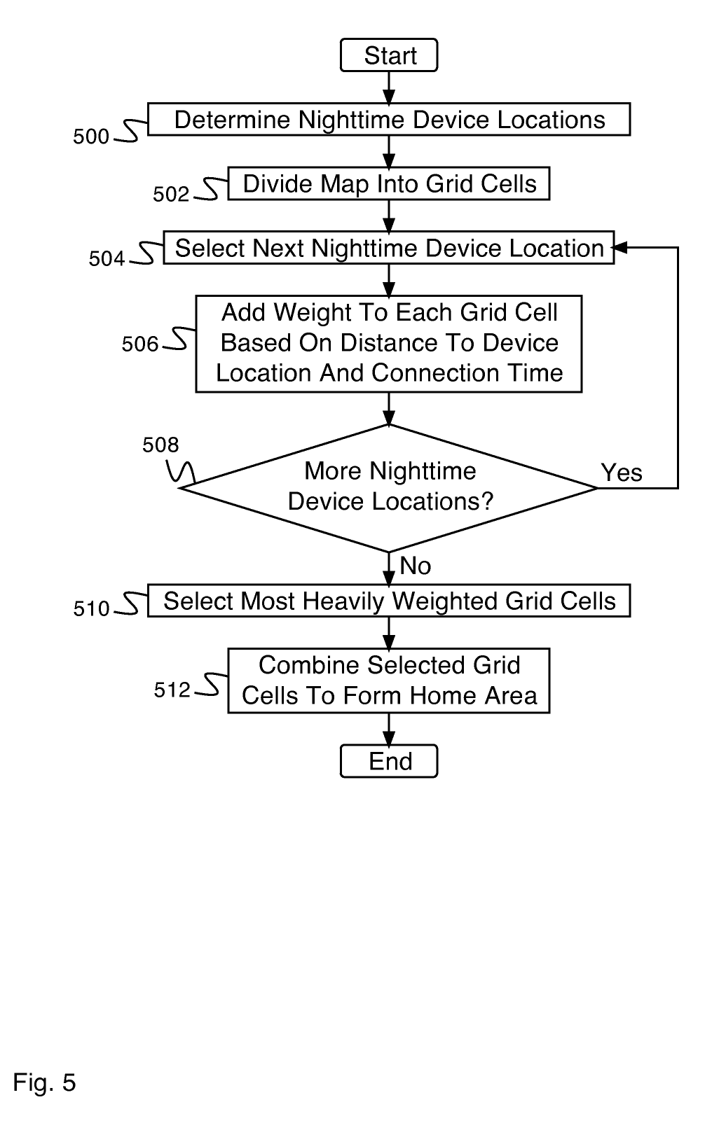

FIG. 5 is a flow diagram illustrating an embodiment of a process for determining a home location. In some embodiments, the process of FIG. 5 implements 400 of FIG. 4. In the example shown, in 500, nighttime device locations are determined (e.g., nighttime device locations for a given user). In some embodiments, determining nighttime device locations comprises determining device locations at a particular time in the middle of the night (e.g., 4 AM). In some embodiments, determining nighttime device locations comprises selecting connections made at any point in a nighttime range (e.g., 9 PM-7 AM). In 502, a map of the area is divided into grid cells. In some embodiments, grid cells comprise small discrete areas (e.g., city blocks or 1 kilometer squares) on which to evaluate the probability of an area being a user's home location. In 504, the next nighttime device location is selected. In some embodiments, the next nighttime device location comprises the first nighttime device location. In 506, weight is added to each grid cell based on the distance to the device location and connection time. In some embodiments, each grid cell within the connection radius associated with the nighttime device location receives an amount of weight related to the connection time. In some embodiments, grid cells closer to the maximum likelihood point receive more weight. In 508, it is determined whether there are more nighttime device locations. In the event there are more nighttime device locations, control passes to 504. In the event there are not more nighttime device locations, control passes to 510. In 510, the most heavily weighted grid cells are selected. In various embodiments, the one most heavily weighted grid cell is selected, the five most heavily weighted grid cells are selected, the top 1% most heavily weighted grid cells are selected, the top 20% most heavily weighted grid cells are selected, or any other appropriate most heavily weighted grid cells are selected. In 512, the selected grid cells are combined to form the home area. In some embodiments, different components of the home area have different likelihood weights. So, for example, a left-hand side could be more likely than a right-hand side but both are still in the home area. In some embodiments, the most likely cell (e.g., the heavily weighted cell) comprises the cell in which the user lives. In some embodiments, a cell is 100 meters by 100 meters. In some embodiments, up to 5 cells are picked for the home area.

In various embodiments, a process similar to FIG. 5 is used with regard to daytime locations, workplace, or any other appropriate location. In some embodiments, a day time location is indicative of a user's workplace.

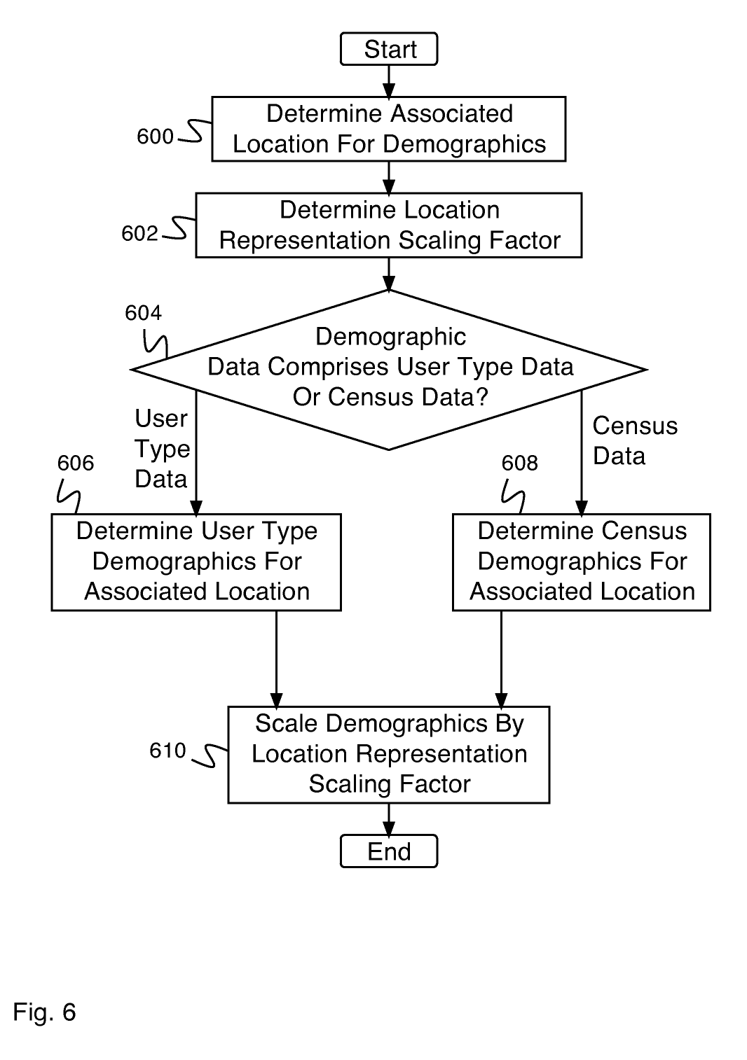

FIG. 6 is a flow diagram illustrating an embodiment of a process for determining demographics associated with a device. In some embodiments, the process of FIG. 6 implements 206 of FIG. 2A. In the example shown, in 600, an associated location for demographics is determined. In various embodiments, an associated location for demographics comprises a home location, a work location, an exercise location, or any other appropriate location. In 602, a location representation scaling factor is determined. In some embodiments, a location representation scaling factor comprises a scaling factor accounting for the fact that the not all people associated with the associated location for demographics have data associated with them (e.g., the set of connection records comprises customers of one or more cellular service providers, which comprises a subset of the total population). In 604, it is determined whether the demographic data comprises user type data or census or census-like data. In some embodiments, user type data comprises derived data (e.g., derived by the system for determining demographic data) describing characteristics of a user. In various embodiments, user type data comprises one or more of the following: heavy shopper data, stay at home parent data, commuter data, shopper with disposable income data, college student data, gender data, or any other appropriate user type data. In some embodiments, census data comprises received data describing quantitative user statistics. In various embodiments, the census data comprises one or more of the following: age data, income data, ethnicity data, gender data, employment data, education, household composition, political preferences, buying habits, immigration, language spoken at home, family status data, or any other appropriate data. In the event the demographic data comprises user type data, control passes to 606. In 606, user type demographics are determined for the associated location. In some embodiments, user type demographics are determined from a user type demographic database built by the system for determining demographic data. In some embodiments, a user type demographic database is built by determining a user type and an associated location (e.g., a home location) for each user and building a set of user type statistics for each location (e.g., the proportions of each user type for each location. In some embodiments, the user types are determined using the site type/visit frequency tables to assign probabilities for the user type. In some embodiments, the user type is based at least in part on the user demographics. Control then passes to 610. In the event it is determined in 604 that demographic data comprises census data, control passes to 608. In 608, census demographics are determined for the associated location. In some embodiments, census demographics are determined from a database of census data. In some embodiments, a database of census data received from an external source (e.g., the census board or another appropriate external supplier of demographic information). Control then passes to 610. In 610, the demographics are scaled by the location representation scaling factor. In some embodiments, the process of FIG. 6 uses census-like data instead of or in addition to census data.

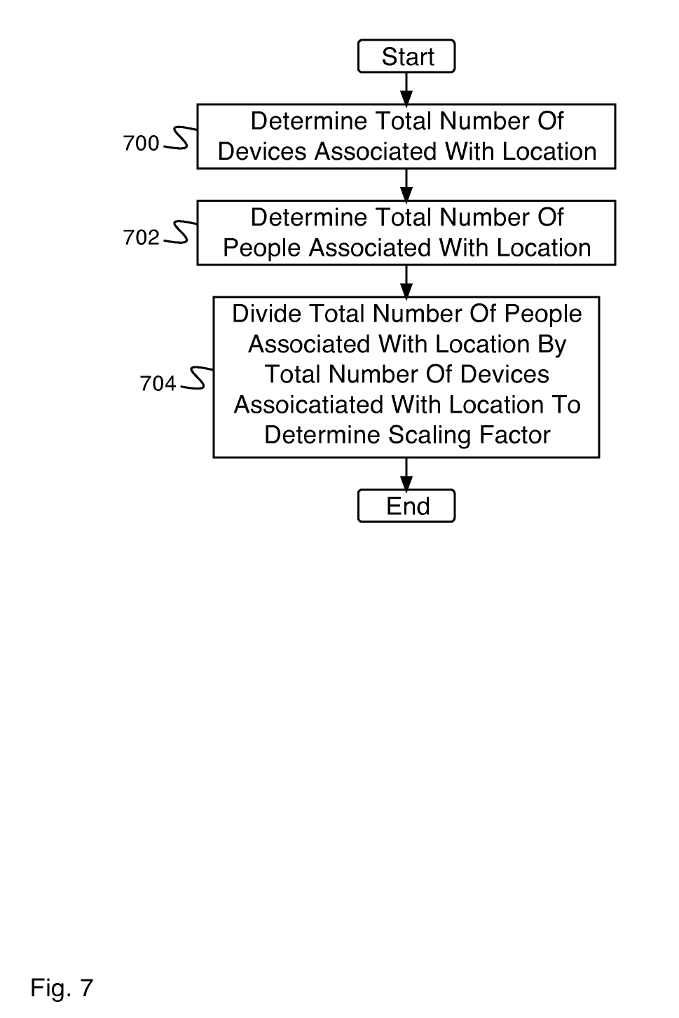

FIG. 7 is a flow diagram illustrating an embodiment of a process for determining a location representation scaling factor. In some embodiments, the process of FIG. 7 implements 602 of FIG. 6. In the example shown, in 700, the total number of devices associated with the location is determined (e.g., where the location is a home location, the total number of devices with the location as home location is determined). In 702, the total number of people associated with the location is determined (e.g., where the location is a home location, the total number of people living at the location is determined, e.g., via census data). In 704, the total number of people associated with the location is divided by the total number of devices associated with the location to compute the scaling factor (e.g., to determine how many people are represented by each device).

In some embodiments, the process of FIG. 7 is performed for other location types using census-like data. For example, worker count data is used for work locations.

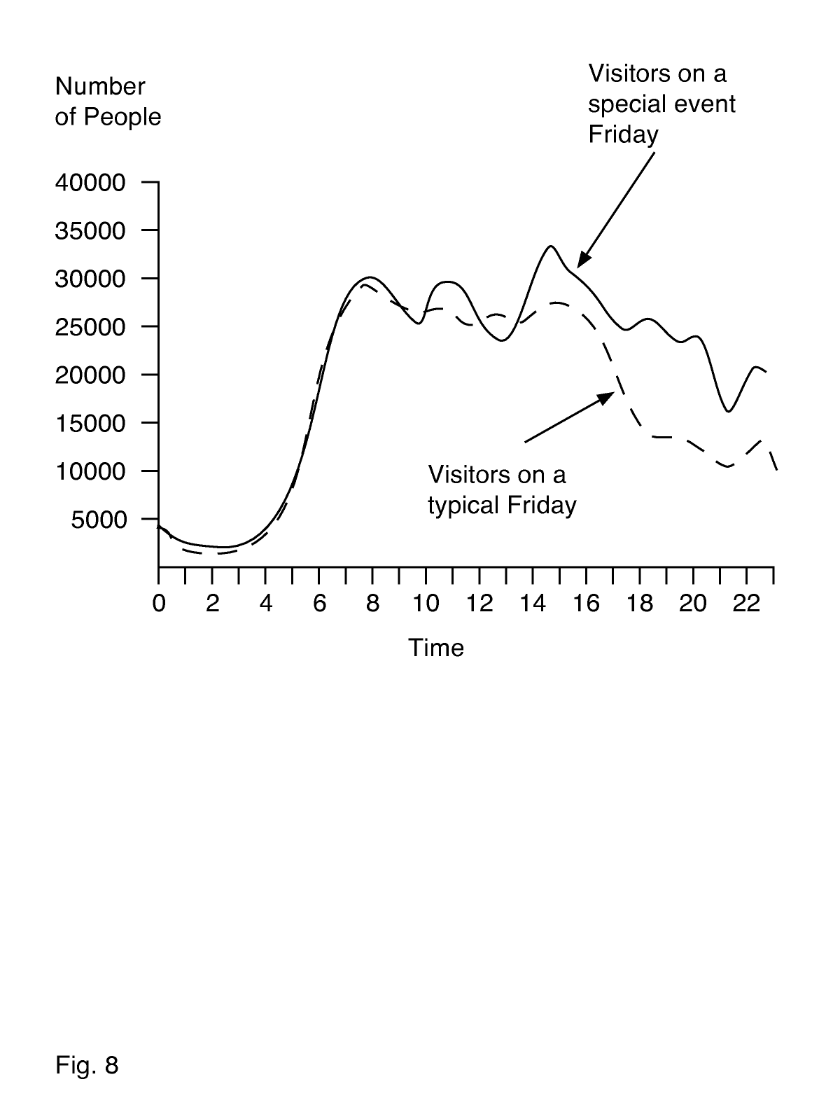

FIG. 8 is a line graph illustrating a comparison between the number of visitors to an area on a typical Friday and a special event Friday. In some embodiments, the graph of FIG. 8 was obtained using the process of FIG. 2A to determine the number of people in an area as a function of time. In various embodiments, the process of FIG. 2A can be used to break down the data shown in FIG. 8 into home locations of visitors to the area, work locations of visitors to the area, demographics of visitors to the area (e.g., race, gender, income, age, education, family status, shopping habits, etc.) or into any other appropriate subgroup. Subgroup data can then be plotted versus time in a similar way as the graph of FIG. 8.

In the example shown, on a typical Friday, the number of people in the area stays significantly higher through the evening (e.g., at 7 PM) than overnight (e.g., at 2 AM), indicating that the area is popular for nightlife. However, the number of people is even higher during working hours, indicating that the area is primarily used for business and nightlife is secondary. On a special event Friday, the population through the evening is comparable to during a typical workday, nearly twice that of a typical Friday evening, indicating a large number of people come to the area for the special event. The peak population on the special event Friday occurs at approximately 3 PM, potentially due to the overlap between people arriving at the event and people remaining in the area for work. The evening population drops off sharply starting at 8 PM, potentially indicating the event is an art gallery-based event, as 8 PM is a typical time for art galleries to close.

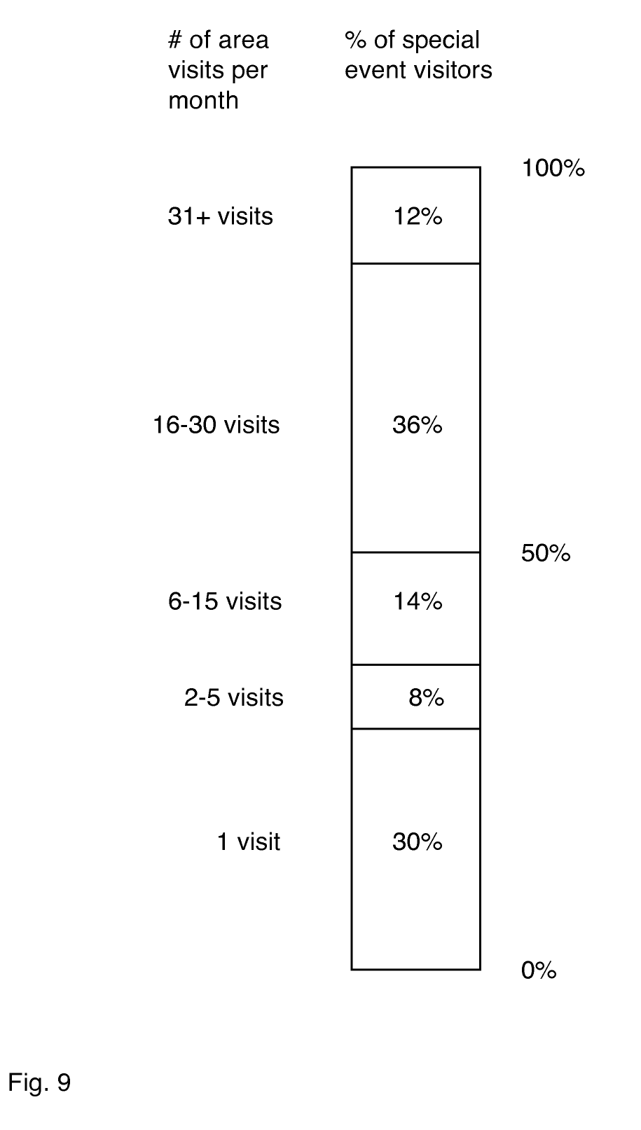

FIG. 9 is a stacked bar graph illustrating data describing visitors to an area during a special event. In the example shown, the stacked bar graph of FIG. 9 shows the fractions of visitors to an area during a special event that visit the area different numbers of times per month. In some embodiments, the graph of FIG. 9 was obtained using the process of FIG. 2A to determine the number of people in an area and the total number of times they visited over the course of a month. In various embodiments, the process of FIG. 2A can be used to break down the data shown in FIG. 9 into home locations of visitors to the area, work locations of visitors to the area, demographics of visitors to the area (e.g., race, gender, income, age, education, family status, shopping habits, etc.) or into any other appropriate subgroup. Subgroup data can then be shown in a stacked bar graph in a similar way as the graph of FIG. 9.

In the example shown, 30% of the visitors to the area during the event visit only once per month (e.g., for the event). These visitors represent the people drawn to the area specifically for the event, and demonstrate the economic benefit to the area of holding the special event. Thirty-six percent of visitors visit the area 16-30 times per month, and thus likely work in the area, and 12% of visitors visit 31 or more times per month, and thus likely live in the area. The remaining 22% of visitors who visit either 2-5 or 6-15 times per month likely live in the vicinity, but are brought to the area specifically for the event. We can deduce that fully 50% of people in the area were brought there for the event, while the other 50% are regular visitors that would likely have been in the area anyway.

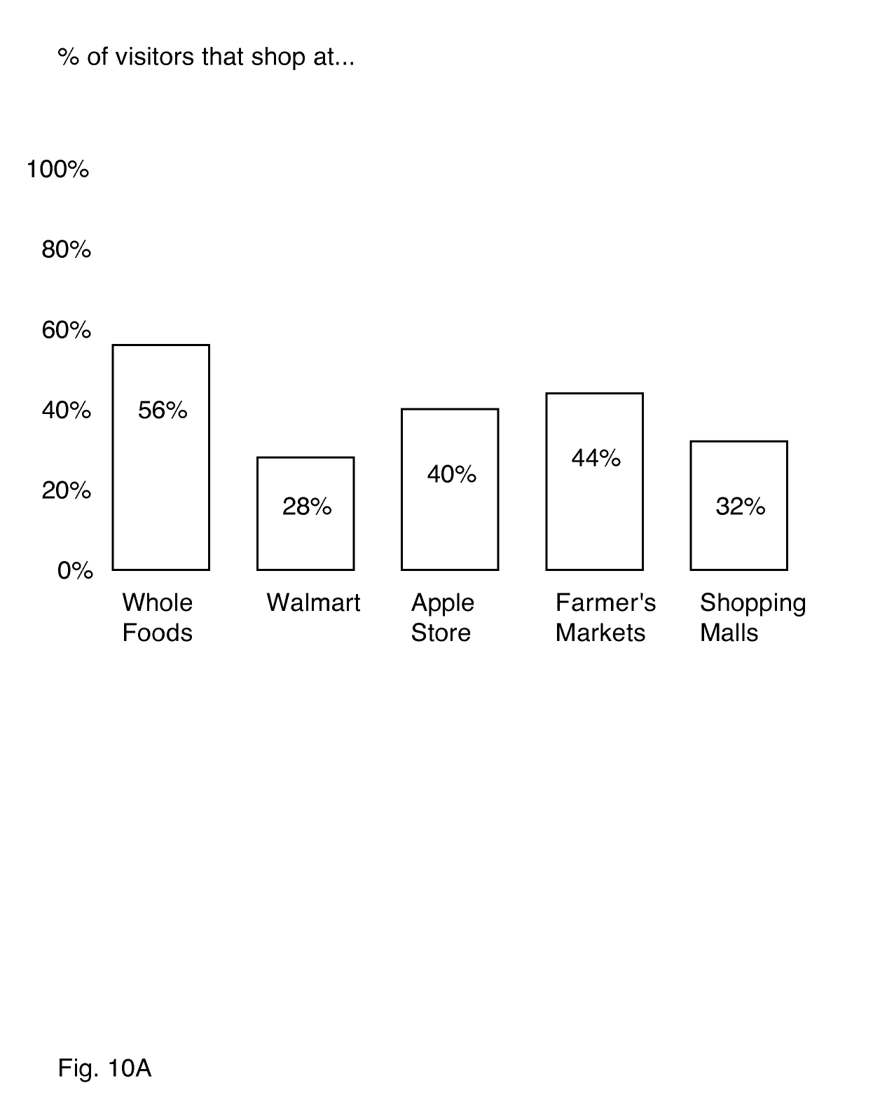

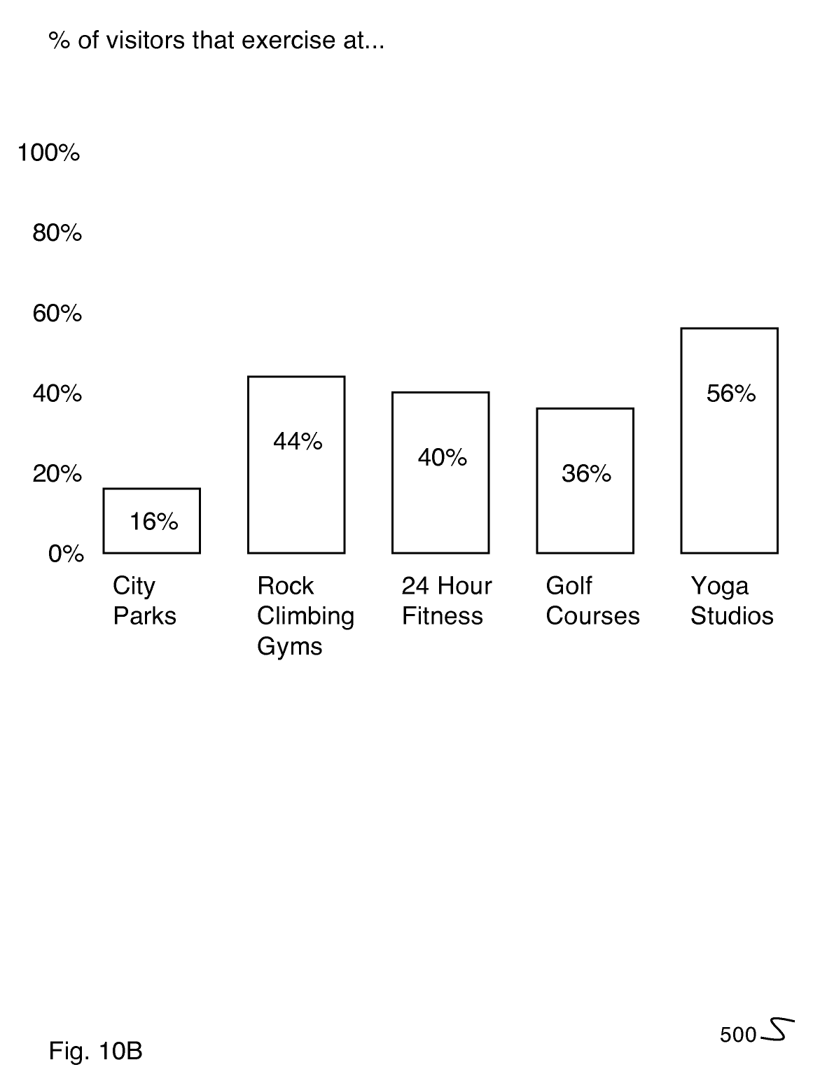

FIG. 10A is a bar graph illustrating data describing demographics of visitors to an area. In the example shown, the bar graph of FIG. 10A shows the fraction of visitors to an area that shop at various different stores. In some embodiments, the graph of FIG. 10A was obtained using the process of FIG. 2A to determine whether people visiting the area were also seen at various shopping locations. In various embodiments, the process of FIG. 2A can be used to break down the data shown in FIG. 10A into home locations of visitors to the area, work locations of visitors to the area, other demographics of visitors to the area (e.g., race, gender, income, age, education, family status, etc.) or into any other appropriate subgroup. Subgroup data can then be shown in a bar graph in a similar way as the graph of FIG. 9. In the example shown, a large fraction of the population is seen to shop at Whole Foods, indicating that they potentially have disposable income, and at farmer's markets, indicating that the have concern about food quality and supporting their community. A relatively low fraction of visitors are seen to shop at Walmart. A businessman considering opening a new grocery market would be wise to take this information into account.

FIG. 10B is a bar graph illustrating data describing demographics of visitors to an area. In the example shown, the bar graph of FIG. 10A shows the fraction of visitors to an area that exercise at various different locations. In some embodiments, the graph of FIG. 10A was obtained using the process of FIG. 2A to determine whether people visiting the area were also seen at various exercise locations. In various embodiments, the process of FIG. 2A can be used to break down the data shown in FIG. 10A into home locations of visitors to the area, work locations of visitors to the area, other demographics of visitors to the area (e.g., race, gender, income, age, education, family status, etc.) or into any other appropriate subgroup. Subgroup data can then be shown in a bar graph in a similar way as the graph of FIG. 9. In the example shown, a large fraction of people are seen to use a number of demographically different exercise locations, including rock climbing gyms, 24 Hour Fitness™ locations, golf courses, and yoga studios. Only city parks are not well utilized by the population. The high demand for exercise locations and low usage of city parks potentially indicates that the parks are seen as undesirable locations to exercise, and investments made by the city to fix this would be appreciated by the population.

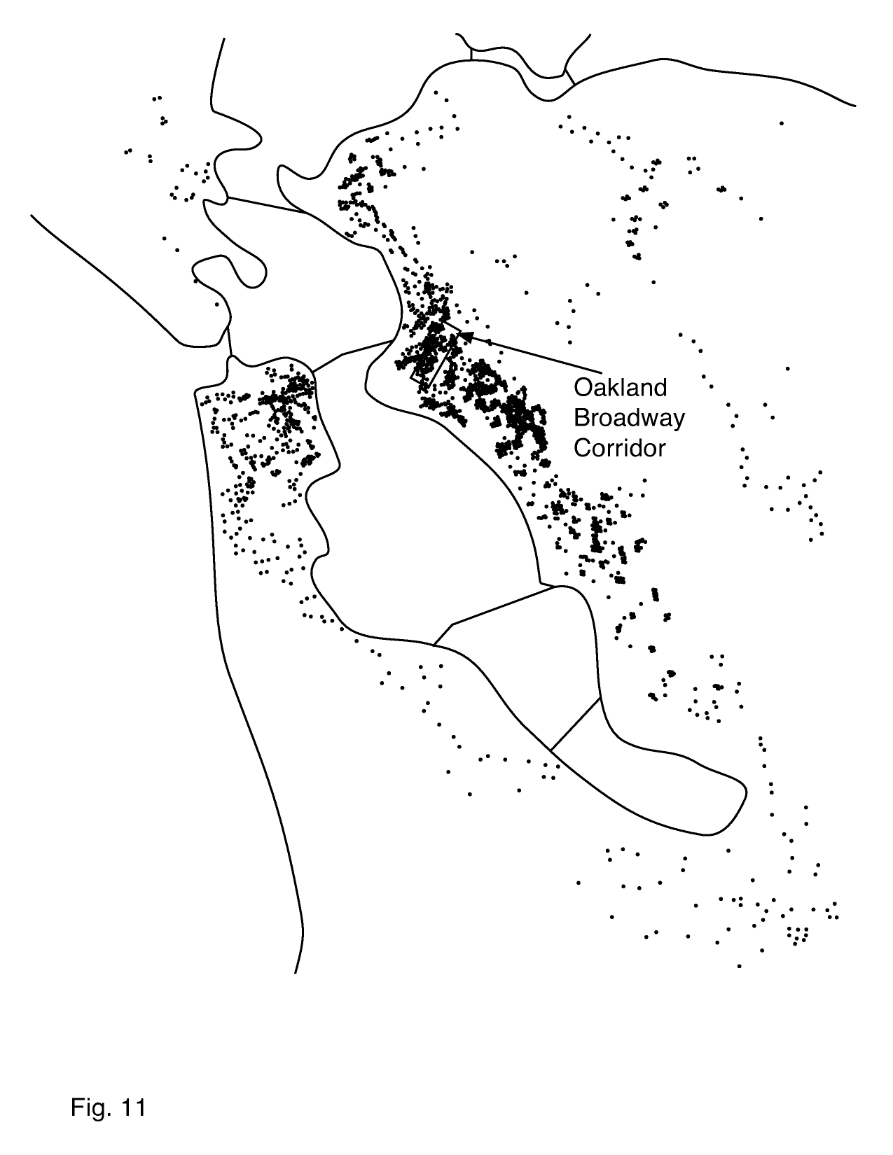

FIG. 11 is a map illustrating data describing home locations of all visitors to a location of interest in a given month. In the example shown, the location of interest comprises the Oakland Broadway Corridor, indicated by a rectangle describing its approximate area. Each dot indicates the home location of approximately 500 visitors to the Broadway Corridor. In some embodiments, the map of FIG. 11 was obtained using the process of FIG. 2A to determine the home locations of visitors to the area. In various embodiments, the process of FIG. 2A can be used to break down the visitors shown in FIG. 11 into, work locations of visitors to the area, demographics of visitors to the area (e.g., race, gender, income, age, education, family status, shopping habits, etc.) or into any other appropriate subgroup. The data of FIG. 11 indicate that that visitors to the Oakland Broadway Corridor include a wide cross-section of bay area residents, living in all the different places bay area residents live. A large portion of San Francisco is represented, demonstrating that many people who live in San Francisco head east for work or play, rather than the bay traversals comprising solely east bay residents who travel to the city.

In various embodiments, the process of FIG. 2A can be used to determine, and the graph types shown in FIG. 8, FIG. 9, FIG. 10A, FIG. 10B, and FIG. 11 can be used to show, home locations of visitors to an area, work locations of visitors to an area, demographics of visitors to an area (e.g., race, gender, income, age, education, family status, shopping habits, etc.), trip origins (e.g., where visitors were before visiting the area), subsequent locations (e.g., where visitors went to after visiting the area), trip distributions (e.g., fraction of trips that are short, fraction of trips that are long, etc.), shopping locations visited, average number of visitors (e.g., per hour, per day, weekday vs. weekend, typical day vs. special event day, etc.), demographics of cars that pass by a location (e.g., make, model, year, etc.), number of vehicles that pass by with good visibility to an area, number of vehicles parked within walking distance to an area, transit demographics (e.g., travel by car, travel by rail, travel by food, travel by bicycle, travel by bus, etc.), visit frequency (e.g., number of visitors that visit once per week, number of visitors that visit twice a day, frequency of first-time visitors, etc.), trip unusualness (e.g., number of visitors that come as part of their daily routine, number of visitors that depart their daily routine to visit the location, number of visitors that do not have a daily routine, etc.), trip type (e.g., shopping, commute, recreation, etc.), business competitors seen along typical routes to the location, before actions (e.g., what a visitor was doing before visiting the location), after actions (e.g., what a visitor was doing after visiting the location), or any other appropriate visitor metrics.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for displaying a demographic data, comprising:
an input interface configured to:
receive a location data of a device;
receive a display type;
a processor configured to:
determine a user characterization data associated with the device; and
determine a probability that the device is associated with a location of interest; and
an output interface configured to:
provide an aggregated characterization data associated with the location of interest for display according to the display type.

2. The system as in claim 1, wherein the user characterization data comprises a probability that the device is associated with a data of interest.

3. The system as in claim 2, wherein the display type comprises a graph of data versus time.

4. The system as in claim 3, wherein the data comprises a number of visitors to a location of interest.

5. The system as in claim 3, wherein the data comprises the fraction of visitors to a location of interest of a demographic of interest.

6. The system as in claim 5, wherein the fraction comprises a weighted sum of demographic data.

7. The system as in claim 6, wherein the weights comprise the probability that the device is associated with a location of interest and the probability that the device is associated with the user characterization data.

8. The system as in claim 2, wherein the display type comprises a fractional data breakdown.

9. The system as in claim 8, wherein the data comprises visitors to a location of interest.

10. The system as in claim 8, wherein the fractional data breakdown comprises a fractional data breakdown by demographic types of interest.

11. The system as in claim 10, wherein the fractional data breakdown comprises a weighted sum of demographic data.

12. The system as in claim 11, wherein the weights comprise the probability that the device is associated with a location of interest and the probability that the device is associated with the user characterization data.

13. The system as in claim 2, wherein the display type comprises a map.

14. The system as in claim 13, wherein the map displays an intensity or density of visitors associated with the location of interest.

15. The system as in claim 14, wherein the map displays changes in visitor characteristics based at least in part on an external factor.

16. The system as in claim 15, wherein the external factor comprises one or more of the following: a time, a weather condition, or an event.

17. The system as in claim 14, wherein the intensity or the density is associated with a home location, a work location, a school location, a shopping location, or an exercise location.

18. The system as in claim 17, wherein the intensity or density indicates a weighted sum of demographic data.

19. The system as in claim 18, wherein the weights comprise the probability that the device is associated with a location of interest and the probability that the device is associated with the user characterization data.

20. A method for displaying a demographic data, comprising:
receiving a location data of a device;
receiving a display type;
determining, using a processor, a user characterization data associated with the device;
determining a probability that the device is associated with a location of interest; and
providing an aggregated characterization data associated with the location of interest for display according to the display type.

21. A computer program product for displaying a demographic data, the computer program product being embodied in a tangible computer readable storage medium and comprising computer instructions for:
receiving a location data of a device;
receiving a display type;
determining a user characterization data associated with the device;
determining a probability that the device is associated with a location of interest; and
providing an aggregated characterization data associated with the location of interest for display according to the display type.
